(19) United States
(12) Patent Application Publication
(10) Pub. No.: US 2012/0251259 A1
(43) Pub. Date: Oct. 4, 2012

(54) IMPLANTATION OF BATTERY RACKS IN A CONTAINER

(75) Inventors: Alexandre NARBONNE, Bordeaux (FR); Julien BOBINET, Saint Loubes (FR)

(73) Assignee: SAFT, Bagnolet (FR)

(21) Appl. No.: 13/436,431

(22) Filed: Mar. 30, 2012

(30) Foreign Application Priority Data
Apr. 1, 2011 (FR) 11 52 845

(51) Int. Cl. B60P 7/10

(52) U.S. Cl. 410/32

(57) ABSTRACT

A transportable storage installation (1) with a length of at least 6 m comprising a plurality of racks (2), each rack being intended to contain batteries (3), each rack comprising at least one face (5) for inserting the batteries, at least half of the racks being arranged so that at least one insertion face is arranged perpendicularly to the direction (4) defined by the length of the storage installation, said installation optionally comprising at least one electric energy conversion device and/or one battery management electronic device.

This transportable storage installation may for example be a transport container or a prefabricated shelter.

### FIELD OF THE INVENTION

The invention relates to the field of transport containers and transportable prefabricated shelters used as an installation for storing batteries with view to the use of these batteries as a backup power supply source, in particular for electrical/electronic equipment in the field of telecommunications.

### STATE OF THE ART

Batteries designed from electrochemical cells of the lithium-ion or nickel-metal hydride type intended to be used as a backup power supply source for low voltage telecommunications networks (24 to 48 V) are known. These batteries may be arranged in a modular frame further called crate or rack, the width of which is standardized to 482.6 mm (19 ins). Each rack may contain several batteries each delivering 48 V. A DC/AC converter allows conversion of the DC current generated by the batteries into an alternating current which may be used for supplying power to electronic systems of telecommunications networks. Reference may be made to the site www.saftbatteries.com which gives further information on this type of backup power supply sources, in particular battery systems of the Intensium range.

The IEC 60297 standard sets the width of a rack intended to receive various electric/electronic apparatuses, for example batteries, to 482.6 mm (19 ins). The rack comprises two parallel vertical metal uprights spaced apart by 457.2 mm (i.e. 18 ins). Holes are bored at regular intervals on the front portion of each upright so that they are spaced apart by 464.82 mm (i.e. 18.3 ins), which gives a total rack width of 482.6 mm (i.e. 19 ins). The apparatuses intended to be installed in such an arrangement are often described as <<rackable>>. Their height is usually a multiple of a length called U (for unit), the size of which has been developed for the Eurocard system. One U has the value of 44.5 mm (i.e. 1.75 ins). 1U, 2U, 3U, 4U are common sizes.

A rack equipped with batteries forms a self-contained energy source which may be displaced and installed in proximity to electronic systems which will be powered by these batteries in the case of the mains current being cut off. Several racks may be combined in order to be able to deliver a larger amount of energy to the electronic system. The racks may be grouped in a container which is placed on the chassis of a goods train or on a boat in order to be transported towards a given location.

In the field of transport, a container is a metal box with the shape of a parallelepiped, designed for transporting goods via different transport methods, such as transport by sea. Its dimensions were standardized internationally. According to the ISO standard there exist three large series of containers with set width and height but with variable length. The standard outer dimensions are:
Lengths of 6.058 m (20 ft), 9.087 m (30 ft), 12.192 m (40 ft);
Width of 2.438 m (8 ft);
Heights of 2.591 m (8.5 ft), 2.743 m (9 ft) and 2,9 m (9,6 ft).
   All the containers of these three series have the same width, 2.438 m (8 ft), which allowed the development of container ships. The standard inner dimensions are:
Length of 5.905 m (20 ft) 12.04 m (40 ft);
Width of 2.33 m;
Height of 2.38 m;
Door passage height 2.30 m.

Document US 2009/0293759 describes the use of a container for storing batteries. The container is placed on the chassis of a goods train. The batteries operate as an additional energy source for supplementing the energy produced by the locomotive. They are discharged and contribute to displacing the train when the latter starts climbing. Conversely, they are recharged when the train runs downhill. The container may be removed from the chassis of the train by using a crane.

Document US 2009/0126293 describes a prefabricated shelter with a length comprised between 2.4 and 4.2 (8 and 14 ft) sheltering a plurality of racks supporting electronic equipment.

In backup power supply systems using a container as an installation for storing batteries, the racks are arranged in the direction of the length of the container on one or two rows. For example, reference may be made to the DPR™ 15-100C system equipped with lead batteries, marketed by Xtreme Power, Inc., to A123 systems equipped with batteries of the lithium-ion type, marketed by A123 Systems, Inc., and to the Battery Energy Storage System (BESS) presented at the 11^{th} Conference ELBC (European Lead Battery Conference) in Istanbul, on Sep. 24, 2010. Now with such an arrangement of the racks, it is not possible to obtain sufficient energy density.

An arrangement of racks is therefore sought in a transportable storage installation, which allows an increase in the number of racks per unit surface in said transportable storage installation. By increasing the number of racks, it is possible to increase the surface energy. In particular, an increase in the number of racks per unit surface of a container with standardized dimensions is sought. In particular, an increase in the number of racks with a width of 482.6 mm (19 ins) is sought in a container with standardized dimensions, for example with a length of 6.1 m (20 ft), of 12.2 m (40 ft), of 13.7 m (45 ft) or 16.2 m (53 ft).

### SUMMARY OF THE INVENTION

For this purpose, the invention proposes a transportable storage installation (1) with a length of at least 6 m comprising a plurality of racks (2), each rack being intended to contain batteries (3), each rack comprising at least one face for inserting the batteries, at least half of the racks being arranged so that said at least one insertion face is arranged perpendicularly to the direction defined by the length of the storage installation, said installation optionally comprising at least one electric energy conversion device and/or one battery management electronic device.

The term “insertion face” refers to the side of the rack through which a battery is introduced inside the rack. The insertion face is generally defined as the plane formed by the two parallel vertical metal uprights which are used to secure the battery to the rack. The insertion face also usually serves as an extraction face.

The rack may not comprise parallel vertical metal uprights serving as a frame but it may essentially consist of a horizontal plate on the surface of which means for securing the battery to the horizontal plate are placed. In such a case, the insertion face is the side of the plate which allows bringing the battery into contact with said means for securing the battery to the horizontal plate.

In other words, the invention consists of arranging the racks in the transverse direction of the storage installation. The transportable storage installation is preferably a transport container or a prefabricated shelter.

According to an embodiment, the container is a transport container with dimensions, in particular standardized by the ISO TC-104 standard. The length may be chosen from the group comprising the following values: 6.1 m (20 ft); 12.2 m (40 ft); 13.7 m (45 ft) and 16.2 m (53 ft). The width is 2.438 m (8 ft). The height may be chosen from the group comprising the following values: 2.591 m (8.5 ft); 2.743 m (9 ft) and 2.9 m (9.6 ft).

According to an embodiment, at least 75% of the racks are arranged so that said at least one insertion face is arranged perpendicularly to the direction defined by the length of the storage installation.

According to an embodiment, all the racks are arranged so that said at least one insertion face is arranged perpendicularly to the direction defined by the length of the storage installation.

According to an embodiment, the dimensions of each rack are standardized, in particular by the IEC 60297 standard. The width of each rack is 482.6 mm (19 ins).

According to an embodiment, the storage installation comprises at least two rows of racks arranged perpendicularly to the direction defined by the length of the storage installation and at least one traffic corridor is created between two rows of racks. According to an embodiment, the transportable storage installation comprises at least one row of 4 racks.

According to an embodiment, the storage installation has a length of 6.1 m (20 ft) and comprises 6 rows of 4 racks.

According to an embodiment, the storage installation has a length of 6.1 m (20 ft) and comprises 4 rows of 4 racks and 2 rows of 2 racks.

According to an embodiment, the storage installation has a length of 12.2 m (40 ft) and comprises 12 rows of 4 racks:

According to an embodiment, the storage installation has a length of 12.2 m (40 ft) and comprises 8 rows of 4 racks, two racks of 2 racks and two racks of 3 racks and at least one face of which for inserting the batteries is arranged along the direction of the length of the installation.

According to an embodiment, the storage installation has a parallelepipedal format, and at least one side wall located in the direction defined by the length of the storage installation comprises at least one opening.

According to an embodiment, the storage installation comprises batteries, preferably of the lithium-ion type.

The object of the invention is also an assembly formed by a stack of at least two storage installations according to the invention.

The object of the invention is also an assembly formed by juxtaposing at least two storage installations resting on a same surface.

### SHORT DESCRIPTION OF THE FIGURES

FIG. 1 is a schematic illustration of a battery (3) and of its mounting on a rack (2) of 482.6 mm (19 ins).

FIG. 2 is a schematic illustration of a container (1) of 6.1 m (20 ft) wherein the arrangement of the racks (2) is according to the invention. The container has 4 rows of 4 racks and 2 rows of 2 racks.

FIG. 3 is a schematic illustration of a container (1) of 12.2 m (40 ft) in which the arrangement of the racks (2) is according to the invention. It has 8 rows of 4 racks, 2 rows of 2 racks and 2 rows of 3 racks arranged against the side wall of the container.

FIG. 4 is a schematic illustration of a container (1) according to the prior art as seen from above, in which all the racks (2) are arranged so that their faces for inserting the batteries are arranged along the length of the container (arrangement A).

FIG. 5 is a schematic illustration of a container (1) according to the invention, as seen from above, in which all the racks (2) are arranged so that the faces for inserting the batteries are arranged along the width of the container (arrangement B). The width of the racks is 482.6 mm (19 ins).

FIG. 6 is a schematic illustration of a container (1) according to the invention as seen from above, in which:
75% of the racks (2) are arranged so that the faces for inserting the batteries are arranged along the width of the container;
25% of the racks (2) are arranged so that the faces for inserting the batteries are arranged along the length of the container, (arrangement C).

In FIGS. 4-6, the width of the racks is 482.6 mm (19 ins) and the width of the container is 2.438 m (8 ft).

FIG. 7 illustrates the number of racks which may be housed in a container depending on their arrangement: arrangement A according to the prior art as illustrated in FIG. 4; arrangements B and C according to the invention as illustrated in FIGS. 5 and 6.

FIG. 8 illustrates a top view of a field of use wherein six containers are installed according to the invention with a length of 6.1 m (20 ft), which may each deliver an energy of 560 kW.h.

FIG. 9 illustrates a top view of a field of use in which three containers are installed according to the invention with a length of 12.2 m (40 ft), which may each deliver an energy of 1,200 kW.h.

FIG. 10 illustrates a top view of a field of use in which six containers are installed according to the prior art with a length of 16.2 m (53 ft), which may each deliver an energy of 500 kW.h.

### DISCUSSION OF THE EMBODIMENTS

In the invention, the term of battery designates the combination of several electrochemical generators in a series and/or parallel configuration, determined according to the desired rated voltage and amount of energy (W.h) for powering the electric application. The electrochemical generators are placed in a common casing and the assembly is designated by the term of battery. Several batteries may be stacked in a rack. Standards define the dimensions of the racks which may receive the batteries. Without any limitation, mention may be made of the IEC 60297, IEC 60917, IEC 61969 and ETS 300 119-3 (European Telecommunication Standard) standards.

For example, the IEC 60297 standard specified a rack width of 482.6 mm (19 ins).

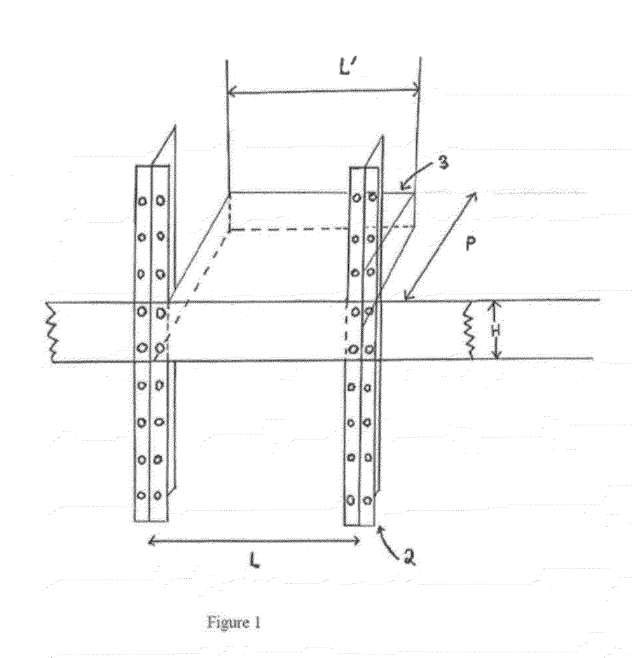

FIG. 1 is a schematic illustration of the face of a rack (2) for inserting a battery (3). This figure indicates the width L of the rack, the width L′, the height H and the depth P of the battery.

The battery has the shape of a parallelepiped. Its width L′ may be equal to 482.6 mm (19 ins) minus the width of both vertical uprights which are used as a frame of the rack, i.e. in the range generally from 406.4 to 457.2 mm (16 to 18 ins). A width equal to half of the width of the rack may also be contemplated, i.e. a width in the range from 203.2 to 228.6 mm (8 to 9 ins).

The battery typically includes on one of its faces a plate with a width of 482.6 mm (19 ins) which generally comprises a switch, indicator lamps indicating the charge condition of the battery to the operator, the ageing condition of the battery, as well as connectors for acquiring data relating to the operation of the battery. The plate may comprise at each of its ends a means for attaching the battery to two vertical uprights of the rack.

As explained above, the insertion face is the plane formed by the two parallel vertical metal uprights which are used to secure the battery to the rack. Once the battery is secured to the two parallel vertical metal uprights, the plate comprising indicator lamps indicating the charge condition of the battery to the operator is thus placed on the insertion face.

The height H of the battery is generally a multiple of a length called U (for unit), the size of which was developed for the Eurocard system. One U has the value of 44.45 mm (1.75 ins). 1U (44.45 mm), 2U (88.9 mm), 3U (133.35 mm) and 4U (177.8 mm) are possible heights.

The depth P of the battery does not meet particular limitations.

The racks equipped with batteries are then installed in a transportable storage installation, such as a container or a prefabricated shelter. A container generally consists of the assembly of several metal panels which give it great strength. Because of their strength, several containers may be superposed. The dimensions of the container preferably meet requirements of the ISO TC-104 standard. The length of the container may assume the following values : 6.1 m (20 ft), 12.2 m (40 ft), 13.7 mm (45 ft) and 16.2 m (53 ft). The width is 2.438 m (8ft ). The height may be chosen from the group comprising the following values: 2.591 m (8.5 ft), 2.743 m (9 ft) and 2.9 m (9.6 ft).

A prefabricated shelter is obtained by assembling panels of various materials, such as concrete, metal, wood and plastic materials. Its dimensions may be standardized. For example, the width may be standardized to 2.4 m, which corresponds to overall road dimensions. It is specified that the transportable storage installation may be displaced from one location to another, for example via a road, via a railway or by sea and that during the transport, the batteries are stored in the installation and are arranged according to the invention. The transportable storage installation may be a pre-fabricated concrete shelter according to road transport standards, which is transported and contains during the transport, batteries laid out according to the arrangement described hereafter.

According to the invention, each rack is installed in the transportable storage installation so that the faces for inserting the batteries are arranged perpendicularly to the direction defined by the length of the storage installation. With this arrangement it is possible to have a larger energy density than for an arrangement in the direction along the length of the storage installation.

Several storage installations may either be stacked on each other, or placed side by side and rest on a same surface.

For a container with a standardized width of 2.4 m (8 ft), the racks may be grouped together in order to form a row of 4 racks, the total length of which is 4×19 ins=76 ins i.e. 1.93 m. Such an alignment practically occupies the whole internal width of the container which is standardized to 2.33 m.

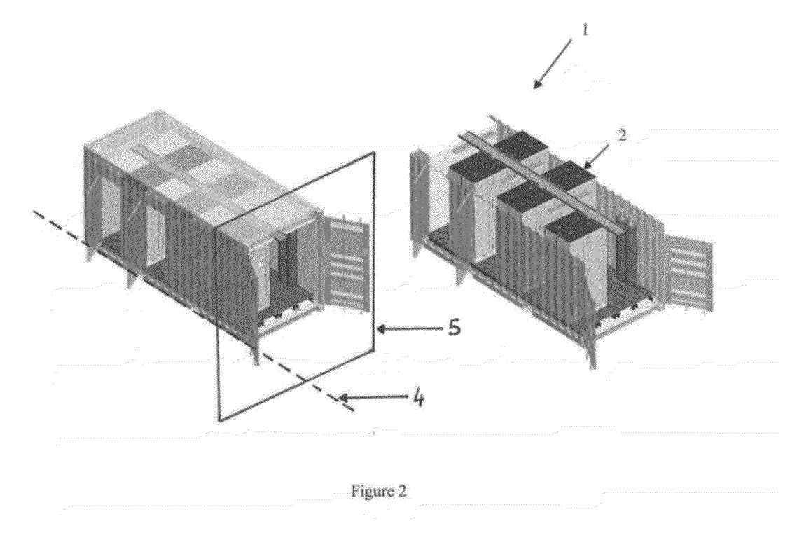

A 6.1 m (20 ft) long container may for example receive 6 rows of 4 racks. Provision may also be made for making a free space for storing for example a piece of fire-fighting equipment, by creating 4 rows of 4 racks and 2 rows of 2 racks as illustrated in FIG. 2. The direction defined by the length of the storage installation is shown with a dotted line (4). The face for inserting batteries is shown with plane (5). The plane (5) is perpendicular to the direction (4) defined by the length of the storage installation.

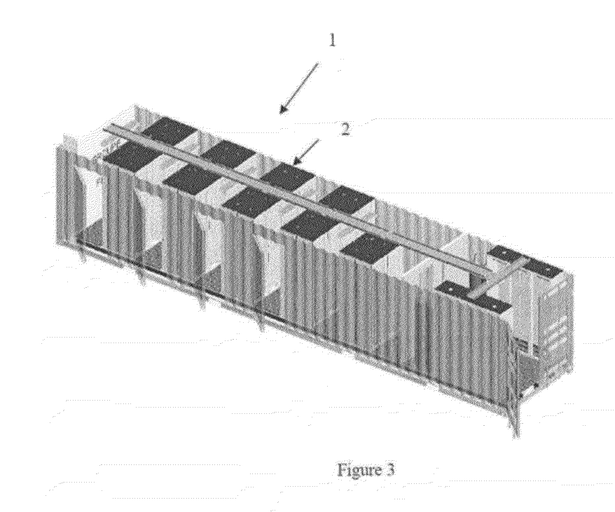

A 12.2 m (40 ft) long container may for example receive:
12 rows of 4 racks or
8 rows of 4 racks, 2 rows of 2 racks and 2 rows of 3 racks arranged against the side wall of the container in the direction of the length of the container. his embodiment is illustrated in FIG. 3.

Preferably, the storage installation comprises at least one energy conversion device such as an inverter, a transformer, a charger, a converter such as a DC/DC converter, a DC/AC converter, an AC/DC converter or an AC/AC converter.

These devices may be of various dimensions. In certain cases, these devices are in cabinets which may be arranged like the racks of the invention. In other cases, their dimensions are not standardized.

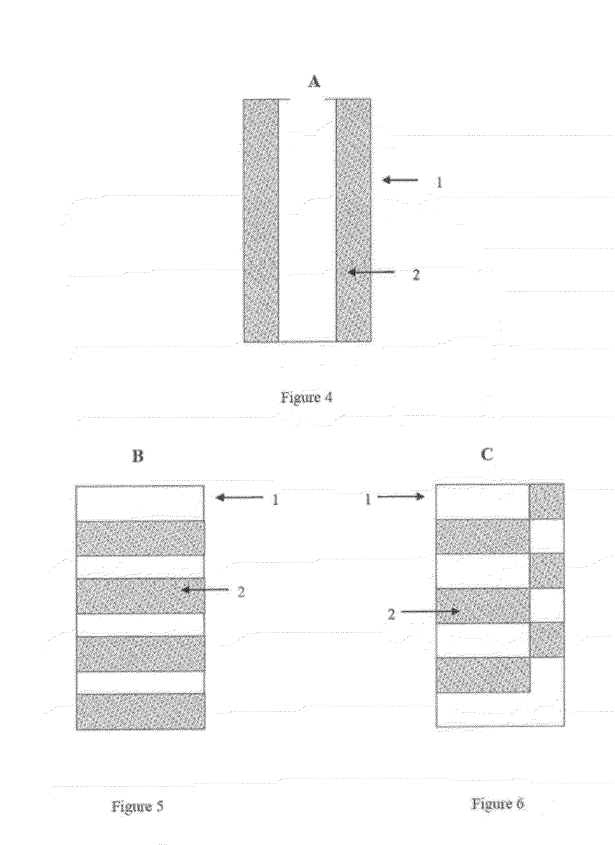

FIG. 4 is a schematic illustration of a container according to the prior art, in which all the racks are arranged so that their faces for inserting the batteries are arranged in the direction along the length of the container.

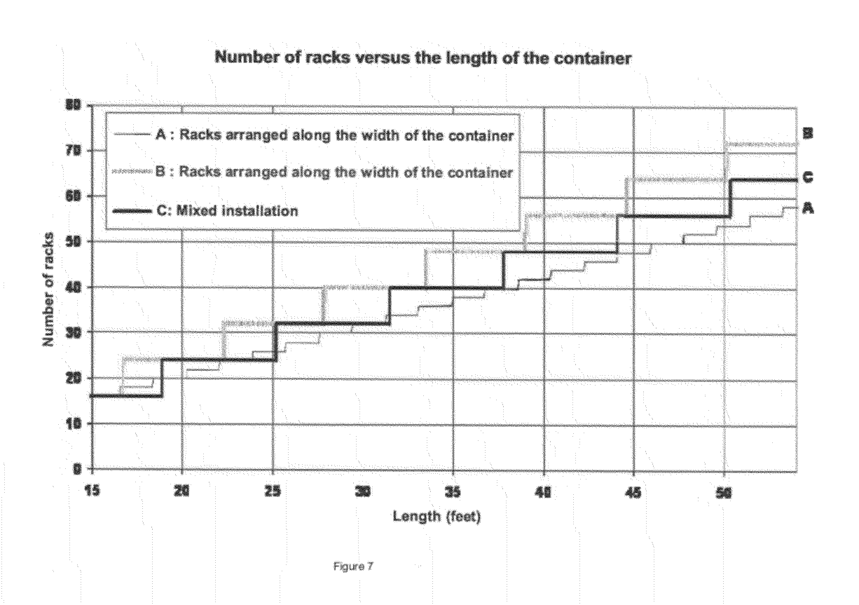

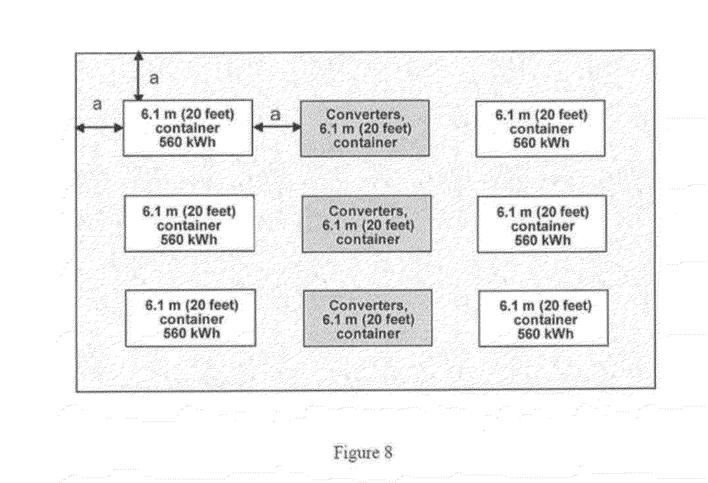

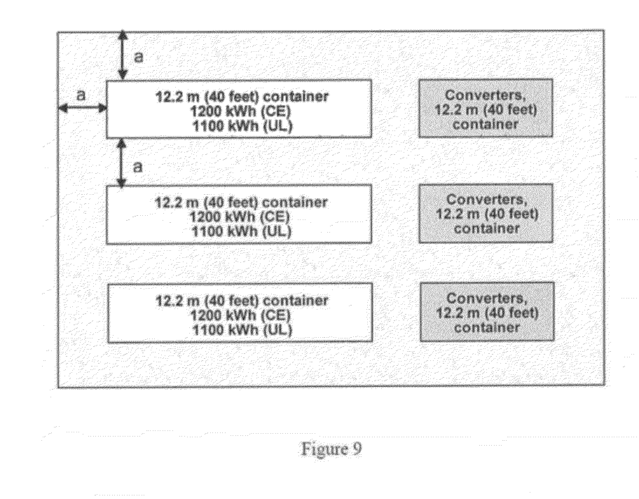

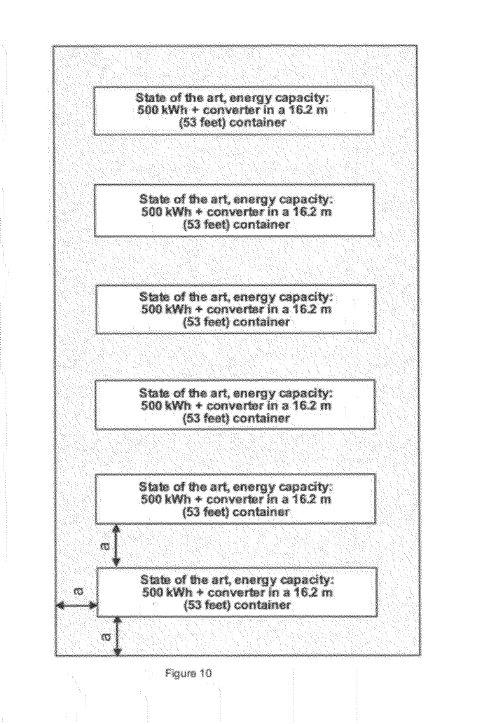

FIG. 5 is a schematic illustration of a container according to the invention, in which all the racks are arranged so that their faces for inserting the batteries are arranged perpendicularly to the direction defined by the length of the container.

FIG. 6 is a schematic illustration of a container according to the invention, in which:

75% of the racks are arranged so that their faces for inserting the batteries are arranged perpendicularly to the direction defined by the length of the container;

25% of the batteries are arranged so that their faces for inserting the batteries are arranged along the direction defined by the length of the container.

FIG. 7 illustrates the number of 482.6 mm (19 ins) racks which may be housed in a container with a width of 2.438 m (8 ft) depending on the arrangement of the racks: an arrangement according to the prior art as illustrated in FIG. 4; arrangements according to the invention such as illustrated in FIGS. 5 and 6. It is seen that for a container with a length of 6.1 m (20 ft), 24 racks may be installed for the arrangements B and C while for the arrangement A, only 20 racks may be installed, i.e. a gain of 20%. It is seen that for a container with a length of 12.2 m (40 ft), 56 and 48 racks may be respectively installed for the arrangements B and C while for the arrangement A, only 42 racks may be installed, i.e. a gain of 33% for the arrangement B relatively to the arrangement A. The arrangements B and C are those which provide the greatest energy density.

One of the advantages of the invention is that each face of the rack is available to the operator, which is not the case in the arrangement of the prior art in which one of the two faces of the rack rests against one of the side walls of the container. According to the invention, as both faces of the rack are available, the number of racks is reduced and therefore their cost.

An additional advantage of the arrangement according to the invention is that traffic corridors are created between two rows of racks arranged in the direction of the width of the container. They have the minimum width allowed by the standards and require the opening of doors in the side wall of the container. They allow an operator to check the operation of the batteries.

An additional advantage of the arrangement according to the invention is the reduction of heating inside the container. Indeed, for an equal amount of energy, by reducing the size of the container to 12.2 m (20 ft) it is possible to reduce the heating of the container by the sun. The air conditioning power of the inside of the container may thus be reduced. The transport of the container is also easier.

An additional advantage of the arrangement according to the invention is that because of the reduction in the container size, it is possible to install the latter in an area which is difficult to access, for example a mountain path.

The installation of a field of containers requires free spaces around the containers. These spaces should be sufficient for:

allowing circulation of men and vehicles;
allow circulation of hoists;
preventing propagation of a possible blaze;
being able to implant electric power networks serving the container.

For a given set of containers with a total energy capacity of 3 MW.h, the required field of use was established and the surface energy for three typical distances between containers was calculated. The comparison was conducted between two types of container according to the invention and one exemplary container representative of the prior art.

The tables below summarize the energy densities of the different configurations according to the space between containers (parameter “a”)

| | | |
|---|---|---|
| | | 16.2 m (53 ft) |
| | 12.2 m (40 ft) | container with an |
| 6.1 m container | container | energy capacity of |
| (20 ft) with an | with an energy | 560 kW · h |
| energy capacity | capacity of | according to the |
| of 560 kW · h | 1.1 MW · h | invention including |
| according to the | according | the DC/AC |
| invention | to the invention | converter |

Energy per surface unit (kW · h/m²) for a 1.5 m space between containers

| | | | |
|---|---|---|---|
| Number of | 6 | 3 | 6 |
| containers | | | |
| Number of | 3 | 3 | 0 |
| converters | | | |
| Surface area of | 143 | 143 | 252 |
| the containers | | | |
| (m²) | | | |
| Surface area of | 341 | 321 | 510 |
| the field of use | | | |
| (m²) | | | |
| Energy per unit | 9.9 | 10.3 | 5.9 |
| surface | | | |

Energy per unit surface (kW · h/m²) depending on the distance a between
the containers

| | | | |
|---|---|---|---|
| a = 5 m | 3.1 | 3.5 | 2.2 |
| a = 10 m | 1.2 | 1.4 | 0.9 |
| a = 15 m | 0.63 | 0.77 | 0.53 |

These calculations show that the energy density benefit of a container unit is retained on a field of use even if this benefit decreases as the free space gradually increases between the containers.

1. A transportable storage installation (1) with a length of at least 6 m comprising a plurality of racks (2), each rack being intended to contain batteries (3), each rack comprising at least one face (5) for inserting the batteries, at least half of the racks being arranged so as said at least one insertion face is arranged perpendicularly to the direction (4) defined by the length of the storage installation, said installation optionally comprising at least one electric energy conversion device and/or one battery management electronic device.

2. The storage installation according to claim 1, which is a transport container or a prefabricated shelter.

3. The storage installation according to claim 2, which is a transport container with dimensions in particular standardized by the ISO TC-104 standard.

4. The storage installation according to claim 1, wherein at least 75% of the racks are arranged so that at least one insertion face is arranged perpendicularly to the direction defined by the length of the storage installation.

5. The storage installation according to claim 4, wherein all the racks are arranged so that said at least one insertion face is arranged perpendicularly to the direction defined by the length of the storage installation.

6. The storage installation according to claim 1, wherein the dimensions of each rack are standardized, in particular by the IEC 60297 standard.

7. The storage installation according to claim 1, comprising at least two rows of racks arranged perpendicularly to the direction defined by the length of the storage installation and at least one traffic corridor is created between two rows of racks.

8. The storage installation according to claim 1, comprising at least one row of 4 racks.

9. The storage installation according to claim 1, with a length of 6.1 m (20 ft) comprising 6 rows of 4 racks.

10. The storage installation according to claim 8, with a length of 6.1 m (20 ft) comprising 4 rows of 4 racks and 2 rows of 2 racks.

11. The storage installation according to claim 8, with a length of 12.2 m (40 ft) comprising 12 rows of 4 racks.

12. The storage installation according to claim 8, with a length of 12.2 m (40 ft) comprising 8 rows of 4 racks, 2 rows of 2 racks and 2 rows of 3 racks, at least one face of which for inserting the batteries is arranged along the direction of the length of the installation.

13. The storage installation according to claim 1, with a parallelepipedal format, wherein at least one side wall located in the direction defined by the length of the storage installation comprises at least one opening.

14. The storage installation according to claim 1, comprising batteries, preferably of the lithium-ion type.

15. An assembly formed by a stack of at least two storage installations, each installation being according to claim 1.

16. An assembly formed by juxtaposing at least two storage installations resting on a same surface, each installation being according to claim 1.
